(19) United States
(12) Patent Application Publication
(10) Pub. No.: US 2026/0228234 A1
(43) Pub. Date: Aug. 6, 2026

(54) DATABASE SYSTEMS AND METHODS FOR VERSIONING CALLS TO EXTERNAL SYSTEMS

(71) Applicant: Salesforce, Inc., San Francisco, CA (US)

(72) Inventors: Chad Hall, Raleigh, NC (US); Kirkland Spector, San Francisco, CA (US)

(73) Assignee: Salesforce, Inc., San Francisco, CA (US)

(21) Appl. No.: 19/043,185

(22) Filed: Jan. 31, 2025

(51) Int. Cl. G06F 16/25; G06F 9/451; G06F 9/54

(52) U.S. Cl. CPC G06F 16/258; G06F 9/451; G06F 9/547

(57) ABSTRACT

Database systems and methods are provided for interacting with external systems using versioning schema of the external systems. One method involves identifying, within code of a component of a graphical user interface (GUI) display, a reference to an external system and an associated version designation, which may utilize a custom versioning schema of the external system that is different from a standard versioning schema at the database system. The method constructs a versioned path for the reference to the external system using the version designation and an integration file associated with the external system, retrieves data from the external system in accordance with the version designation for the reference to the external system using the versioned path, and generates, using the retrieved data according the version designation, a graphical representation of the component within the GUI display of a virtual application provided to a client application at a client device.

### TECHNICAL FIELD

One or more implementations relate to the field of database systems, and more specifically, to managing integration of a database system with different external systems using different versioning schema independent of the database system.

### BACKGROUND

Modern software development has evolved towards web applications or cloud-based applications that provide access to data and services via the Internet or other networks. For example, social media platforms and other collaborative web sites allow users to exchange direct messages or form groups for broadcasting messages and collaborating with one another. In business environments and customer relationship management (CRM) contexts, communication platforms facilitate users sharing information about sales opportunities or other issues surrounding products or services and track changes to projects and sales opportunities by receiving broadcast updates about coworkers, files, and other project related data objects.

In contrast to traditional systems that host networked applications on dedicated server hardware, a “cloud” computing model allows applications to be provided over the network “as a service” or “on-demand” by an infrastructure provider. The infrastructure provider typically abstracts the underlying hardware and other resources used to deliver a customer-developed application so that the customer no longer needs to operate and support dedicated server hardware. Multi-tenant cloud-based architectures have been developed to support multiple user groups (also referred to as “organizations” or “tenants”) using a common hardware and software platform. Some multi-tenant database systems include an application platform that supports a customizable user experience, for example, to create custom applications, web pages, reports, tables, functions, and/or other objects or features.

In business environments and customer relationship management (CRM) contexts, it is often desirable to retrieve or incorporate data or information from various different websites, platforms, database systems, or the like into a web application or website in order to share information, improve collaboration or otherwise enhance or improve the user experience. Various protocols have been developed to facilitate sharing data or information across different websites and applications. That said, many software developers desire greater flexibility and interoperability between different systems without imposing constraints across different systems. Accordingly, it is desirable to facilitate data integration across different platforms or systems with improved flexibility while relaxing constraints of a database system on external systems.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 is a block diagram illustrating a computing system that includes an integration service associated with a virtual application provided by an application platform at a database system according to some example implementations;

FIG. 2 depicts an exemplary graphical user interface (GUI) display suitable for presentation in the computing system of FIG. 1 according to some example implementations;

FIG. 3 depicts an exemplary web page graphical user interface (GUI) display suitable for presentation on a client device by a visual process design service in the computing system of FIG. 1 according to some example implementations;

FIG. 4 is a flow diagram illustrating a version management process suitable for implementation by the integration service in the computing system of FIG. 1 according to some example implementations;

FIG. 5A is a block diagram illustrating an electronic device according to some example implementations; and

FIG. 5B is a block diagram of a deployment environment according to some example implementations.

### DETAILED DESCRIPTION

The following description describes implementations for supporting invocable actions, application programming interface (API) calls or other interactions at endpoints associated with external systems using their own externally-defined versioning schema that may be arbitrary, independent, unique or otherwise different from the versioning schema utilized by the database system and/or other external systems. Rather than the version schema being dictated or statically defined by the database system or at an application or service platform level, the subject matter described herein allows endpoint producers associated with different external systems to independently define their own versioning schema that can be discovered and integrated at the database system at run-time. For example, some external systems or endpoints may utilize a numeric or sequential versioning schema (e.g., 1.0.0, 1.0.1, 1.1.0, 2.0.0, etc.) while other external systems or endpoints may utilize globally unique identifier (GUID) based versioning, semantic versioning (e.g., a.1.0-beta, etc.) or any other sort of combination or amalgamation of alphanumeric characters capable of uniquely identifying different versions. In this regard, endpoint producers may define their own versioning schema to allow respective versions of their API calls or other invocable endpoints to be versioned or referenced in any manner desire while providing corresponding versioning information metadata that allows a service at a database system to order or sort, manage and otherwise differentiate or reason between different versions of a particular API call or endpoint. As described below, the service at the database system is capable of dynamically generating or otherwise constructing the appropriate path for referencing a desired version of a particular API call or endpoint associated with an external system from a version designation using the versioning information metadata maintained at the database system. For example, the versioning information metadata and related operations for ordering, sorting or otherwise differentiating versions may be stored or otherwise maintained in an integration file associated with the external system that is previously uploaded or stored at the database system, thereby allowing the service at the database system to utilize the integration file to dynamically construct a versioned path for invoking the desired version of an invocable action, API call, endpoint or other reference to the external system.

As described in greater detail below, a developer or other user associated with an external system uploads, transmits or otherwise provides an integration file to the database system that includes versioning information metadata associated with one or more invocable references at the external system. In this regard, the versioning information metadata includes information characterizing the schema or parameters for how the particular API call, endpoint or other invocable action at the external system is versioned and defined according to the customized versioning schema for that particular action and/or external system. Additionally, the versioning information metadata includes code or other functionality that can be utilized by a service at the database system to compare values for the respective schema or parameters to identify what values are greater and/or lesser according to that custom versioning schema, along with code or other functionality that can be utilized by the service at the database system to sort, order or perform other logical operations on respective values for parameters of the versioning schema. In this regard, the versioning information metadata maintained by the integration file allows a service at the database system to translate a generic request for that particular API call, endpoint or other invocable action that includes desired version information into an appropriately versioned request that can be dynamically generated at run-time and that reflects the customized versioning schema at the external system before making the versioned request to invoke the desired version of the API call, endpoint or other invocable action.

As described in greater detail below, the versioning information metadata may be utilized in the context of a visual, WYSIWYG, drag and drop, declarative, and/or low code (or no code) designer to allow users to specify and configure the particular version of an API call, endpoint or other invocable action at an external system that the user would like to incorporate or integrate into an application supported by the database system. For example, invocable actions can be incorporated into an application in a visual, WYSIWYG, drag and drop, declarative, or low code (or no code) manner via one or more graphical user interface (GUI) displays using user-configurable web components that allow the user to define the particular version for an API call or action to be associated with the configured web component. In this regard, a service at the database system may parse or otherwise analyze the integration file associated with a particular invocable action at an external system to identify the different versions associated with the action and sort or order the different potential versions for purposes of populating a picklist, drop-down menu or other menu GUI element(s) manipulable by a user to select the desired version. Thereafter, the service at the database system may identify the selected version designation via a GUI element and automatically generate configured code for the configured web component that includes indication of the version designation for the invocable action at the external system. The precise implementation details associated with visual, WYSIWYG, drag and drop, declarative, or low code (or no code) designers are not germane to the subject matter and will not be described in detail herein. For reference, some examples of visual, low code (or no code) WYSIWYG design are described in U.S. Pat. Nos. 11,269,668, 11,321,422 and 11,797,638. That said, in other implementations, any suitable integrated development environment or other code editor may be utilized, which similarly is not germane to the subject matter and will not be described in detail herein.

In one or more implementations, code for a web page associated with the application supported by the database system is updated to include reference to the configured web component that includes indication of the version designation for the invocable action at the external system, which, in turn, is utilized by a service at the database system to dynamically and automatically generate an appropriately versioned path for invoking the desired version of the API call or action at the external system at run-time using the integration file. After constructing the versioned path for the reference to the API call, action or other endpoint at the external system using the version designation and the integration file, the application supported by the database system may automatically execute or otherwise implement the versioned path to invoke the action at the external system and retrieve data from the external system that reflects performance or invocation of the API call or other action at the external system in accordance with the desired version designation. Thereafter, a graphical representation of the configured web component may be automatically generated or otherwise updated based on the data retrieved from the external system in accordance with the version designation to reflect invocation of the desired version of the API call or other endpoint at the external system. Thus, by virtue of the subject matter described herein, different versions of API calls or other invocable actions or endpoints at an external system may be incorporated into instances of a virtual application supported by an application platform at a database system in a manner that allows a developer, administrator or other user associated with the external system to implement their own desired versioning schema that is independent of any standard or default versioning schema utilized by the application platform at the database system and in a manner that is not constrained by the application platform at the database system. In this manner, versions may be delineated, differentiated or otherwise named or defined in any manner desired by developer, administrator or other user associated with the external system provided the integration file at the database system includes code or other metadata that can be parsed and referenced by a service at the database system to compare, sort, order or otherwise perform logical operations on values for respective parameters of the versioning schema to integrate the custom versioning schema into the GUI displays or other functionality supported by the application platform at the database system.

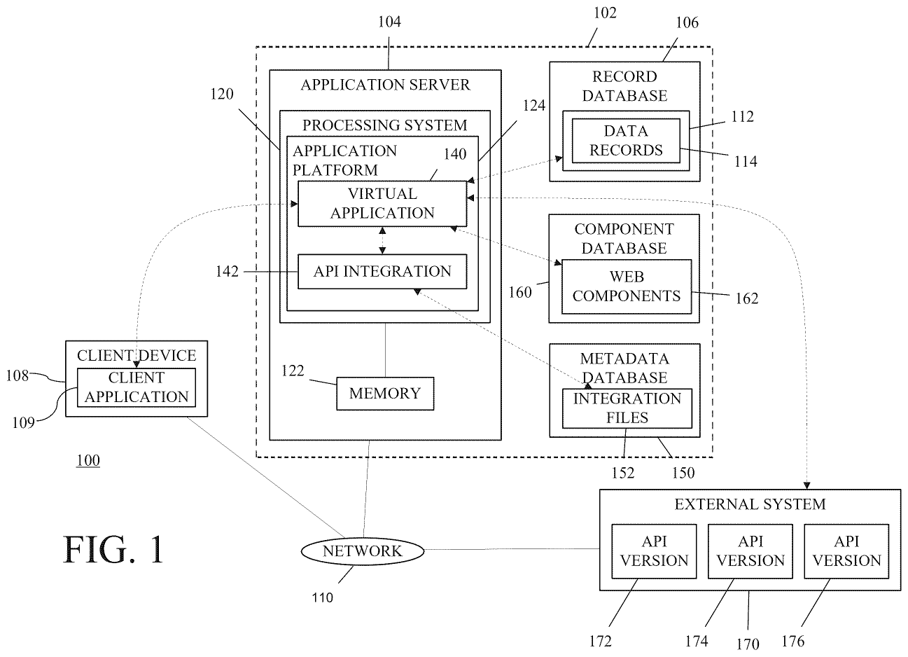

FIG. 1 depicts an exemplary computing system 100 including a database system 102 configurable to provide an application platform 124 capable of concurrently providing instances of one or more virtual applications 140 to client applications 109 at client devices 108 associated with one or more different end users over a communications network 110 (e.g., the Internet or any sort or combination of wired and/or wireless computer network, a cellular network, a mobile broadband network, a radio network, or the like). That said, it should be appreciated that FIG. 1 is a simplified representation of a computing system 100 and is not intended to be limiting. In this regard, it should be noted that although FIG. 1 depicts a database system 102 including multiple different and distinct databases 106, 150, 160, in practice, one or more of the databases 106, 150, 160 may be integrated or otherwise implemented at a common database.

In one or more exemplary implementations, the database system 102 includes one or more application servers 104 that support an application platform 124 capable of providing instances of virtual applications 140, over the network 110, to any number of client devices 108 that users may interact with to view, access or obtain data or other information from one or more data records 114 maintained in one or more data tables 112 at a record database 106 or other repository associated with the database system 102. For example, a record database 106 may maintain, on behalf of a user, tenant, organization or other resource owner, data records 114 entered or created by that resource owner (or users associated therewith), files, objects or other records uploaded by the resource owner (or users associated therewith), and/or files, objects or other records automatically generated by one or more computing processes (e.g., by the server 104 based on user input or other records or files stored in the record database 106). In this regard, in one or more implementations, the database system 102 is realized as an on-demand multi-tenant database system that is capable of dynamically creating and supporting virtual applications 140 based upon data from a common database 106 that is shared between multiple tenants, which may alternatively be referred to herein as a multi-tenant database. Data and services generated by the virtual applications 140 may be provided via the network 110 to any number of client devices 108, as desired, where instances of the virtual application 140 may be suitably generated at run-time (or on-demand) using a common application platform 124 that securely provides access to the data in the record database 106 for each of the various tenants subscribing to the multi-tenant system.

The application server 104 generally represents the one or more server computing devices, server computing systems or other combination of processing logic, circuitry, hardware, and/or other components configured to support remote access to data records 114 maintained in the data tables 112 at the record database 106 via the network 110. Although not illustrated in FIG. 1, in practice, the database system 102 may include any number of application servers 104 in concert with a load balancer that manages the distribution of network traffic across different servers 104 of the database system 102.

In exemplary implementations, the application server 104 generally includes at least one processing system 120, which may be implemented using any suitable processing system and/or device, such as, for example, one or more processors, central processing units (CPUs), controllers, microprocessors, microcontrollers, processing cores, application-specific integrated circuits (ASICs) and/or other hardware computing resources configured to support the operation of the processing system described herein. Additionally, although not illustrated in FIG. 1, in practice, the application server 104 may also include one or more communications interfaces, which include any number of transmitters, receivers, transceivers, wired network interface controllers (e.g., an Ethernet adapter), wireless adapters or other suitable network interfaces that support communications to/from the network 110 coupled thereto. The application server 104 also includes or otherwise accesses a data storage element 122 (or memory), which may be realized as a local disk, hard disk, random access memory (RAM), read only memory (ROM), flash memory, magnetic or optical mass storage, or any other suitable non-transitory short or long term data storage or other computer-readable media, and/or any suitable combination thereof. In exemplary implementations, the memory 122 stores code or other computer-executable programming instructions that, when executed by the processing system 120, are configurable to cause the processing system 120 to support or otherwise facilitate the application platform 124 and related software services that are configurable to support the subject matter described herein.

The client device 108 generally represents an electronic device coupled to the network 110 that may be utilized by a user to access an instance of the virtual application 140 using an application 109 executing on or at the client device 108. In practice, the client device 108 can be realized as any sort of personal computer, mobile telephone, tablet or other network-enabled electronic device coupled to the network 110 that executes or otherwise supports a web browser or other client application 109 that allows a user to access one or more GUI displays provided by the virtual application 140. In exemplary implementations, the client device 108 includes a display device, such as a monitor, screen, or another conventional electronic display, capable of graphically presenting data and/or information along with a user input device, such as a touchscreen, a touch panel, a mouse, a joystick, a directional pad, a motion sensor, or the like, capable of receiving input from the user of the client device 108. Some implementations may support text-to-speech, speech-to-text, or other speech recognition systems, in which case the client device 108 may include a microphone or other audio input device that functions as the user input device, with a speaker or other audio output device capable of functioning as an output device. The illustrated client device 108 executes or otherwise supports a client application 109 that communicates with the application platform 124 provided by the processing system 120 at the application server 104 to access an instance of the virtual application 140 using a networking protocol. In some implementations, the client application 109 is realized as a web browser or similar local client application executed by the client device 108 that contacts the application platform 124 at the application server 104 using a networking protocol, such as hypertext transport protocol secure (HTTPS). In this manner, the client application 109 may be utilized to access or otherwise initiate an instance of a virtual application 140 hosted by the database system 102, where the virtual application 140 provides one or more web page GUI displays within the client application 109 that include GUI elements for interfacing and/or interacting with records 114 maintained at the record database 106.

Still referring to FIG. 1, in exemplary implementations, the record database 106 stores or otherwise maintains data for integration with or invocation by a virtual application 140 in objects organized in object tables 112. In this regard, the record database 106 may include any number of different object tables 112 configured to store or otherwise maintain alphanumeric values or other descriptive information that define a particular instance of a respective type of object associated with a respective object table 112. For example, the virtual application may support a number of different types of objects that may be incorporated into or otherwise depicted or manipulated by the virtual application, with each different type of object having a corresponding object table 112 that includes columns or fields corresponding to the different parameters or criteria that define a particular instance of that object. In some implementations, the record database 106 stores or otherwise maintains application objects (e.g., an application object type) where the application object table 112 includes columns or fields corresponding to the different parameters or criteria that define a particular virtual application 140 capable of being generated or otherwise provided by the application platform 124 on a client device 108. In this regard, the record database 106 may also store or maintain graphical user interface (GUI) objects that may be associated with or referenced by a particular application object and include columns or fields that define the layout, sequencing, and other characteristics of GUI displays to be presented by the application platform 124 on a client device 108 in conjunction with that instance of the virtual application 140.

In exemplary implementations, the record database 106 stores or otherwise maintains additional database objects for association and/or integration with a virtual application 140, which may include custom objects and/or standard objects. For example, an administrator user associated with a particular resource owner may utilize an instance of a virtual application 140 to create or otherwise define a new custom field to be added to or associated with a standard object, or define a new custom object type that includes one or more new custom fields associated therewith. In some implementations, the record database 106 may also maintain metadata that defines or describes the fields, process flows, workflows, formulas, business logic, validation rules, structure and other database components or constructs that may be associated with a particular database object.

In the illustrated implementation, the database system 102 also includes a metadata database 150 that stores or otherwise maintains metadata that defines or describes the fields, process flows, formulas, business logic, structure and other database components or constructs that may be associated with various database objects, virtual applications 140 and/or the application platform 124. To support dynamic component generations described herein, the metadata database 150 may store or otherwise maintain endpoint metadata that includes APIs or other information identifying endpoints for retrieving information associated with the respective fields or other attributes of the different standard and/or custom database objects maintained in the record database 106. In this regard, in exemplary implementations described herein, the metadata database 150 stores or otherwise maintains integration files 152 associated with different APIs, invocable actions or other endpoints for retrieving information from one or more external systems 170. For example, the integration file 152 may include information pertaining to different versions of an API 172, 174, 176 associated with the external system 170 that are exposed or otherwise available as a reference capable of being incorporated at the database system 102.

For a particular API having different versions 172, 174, 176 supported at the external system 170, a developer or other user associated with the external system 170 utilizes a client application 109 at a client device 108 to upload, provide or otherwise define an integration file 152 that includes information identifying the API along with versioning information metadata characterizing the schema or parameters for how the different instances 172, 174, 176 of the API at the external system 170 are versioned, differentiated or otherwise defined according to the particular versioning schema at the external system 170, which may be customized, unique or otherwise different from the versioning schema utilized for different APIs at the database system 102. Additionally, the integration file 152 that includes logical operation information or functions for ordering, sorting or otherwise differentiating the different instances 172, 174, 176, including information or logic that enables comparing different versioning schema parameters to identify what values for different versioning parameters are greater and/or lesser according to that custom versioning schema at the external system 170. For example, in exemplary implementations, the integration file 152 defines an “equals” function that can be invoked to apply business logic to an input version identifier to determine whether it is equal to another version identifier and a “compare To” function that can be invoked to apply business logic to an input version identifier to determine whether it is greater than or less than another version identifier. As described below, the versioning information metadata maintained in the integration file 152 enables the database system 102 to dynamically construct a network address or path for invoking the desired API version 172, 174, 176 at the external system 170 to retrieve data from the external system 170 and incorporate the retrieved external data into an instance of the virtual application 140 at run-time.

In one or more exemplary implementations, the application platform 124 is configurable to facilitate or generate an instance of a virtual application 140 at run-time or on-demand using configured web components 162 associated with the web application that are maintained in a component database 160 coupled to the application server 104. For example, in one or more implementations, the processing system 120 executes programming instructions that are configurable cause the application platform 124 to create, generate, or otherwise facilitate a page generation service capable of generating one or more web page GUI displays corresponding to a virtual application 140 created or otherwise developed by a user based on the configured web components 162 associated with the particular instance of the virtual application 140, for example, by retrieving and rendering the configured web components 162 at run-time in accordance with the user-defined configuration.

In exemplary implementations, the configured web components 162 are created, defined, or otherwise configured by a developer, creator, administrator or other user associated with a particular tenant who inputs, selects, configures or otherwise defines values for fields or parameters for instances of web component templates that have been added or selected for integration with a particular web page GUI display associated with the virtual application 140 for that particular tenant's configuration. For example, a developer of a web application may configure, define or otherwise provide other information for one or more fields of a particular database object type for an instance of a web component template added to a web page GUI display of the virtual application, which, in turn, may be utilized by the application platform 124 and/or a client application 109 to retrieve data from the record database 106 and/or the metadata database 150 for incorporation within the virtual application 140 by populating or otherwise generating the instance of the configured web component 162 using the retrieved data at run-time or on-demand. In this regard, in exemplary implementations described herein, a configured web component 162 may include information identifying a particular version 172, 174, 176 of an API associated with an external system 170, which, in turn, may be utilized by the application platform 124 and/or a client application 109 to retrieve data from the external system 170 via the designated version 172, 174, 176 of the API for populating or otherwise generating the instance of the configured web component 162 using the retrieved external data, as described in greater detail below.

In exemplary implementations, the application platform 124 is configurable to facilitate or generate an integration service 142 in connection with an instance of a virtual application 140 for dynamically generating or otherwise constructing paths to invoke the desired version of an API, action or other endpoint at an external system 170 at run-time or on-demand using configured web components 162. For example, in one or more implementations, the processing system 120 executes programming instructions that are configurable cause the application platform 124 and/or the virtual application to parse the configured web components 162 while generating one or more web page GUI displays corresponding to a virtual application 140 created or otherwise developed by a user based on the configured web components 162 to identify a reference to a particular API, action or other endpoint at an external system 170. In response to identifying a reference to an external system 170, the virtual application 140 initiates, triggers or otherwise invokes the integration service 142 to parse or otherwise analyze the integration file 152 associated with the particular endpoint or reference at the external system 170 to dynamically generate a network path for interacting with the designated version 172, 174, 176 of that particular API, action or other endpoint at the external system 170. The dynamically generated network path is utilized by the application platform 124 and/or the virtual application to retrieve data from the external system 170 via the designated API version 172, 174, 176 and incorporate the retrieved data into a web page GUI display of the virtual application 140, as described in greater detail below.

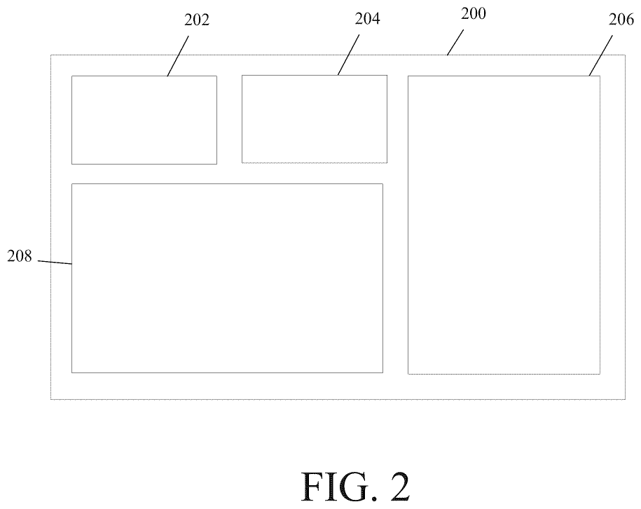

FIG. 2 depicts an exemplary web page GUI display 200 that includes GUI display components 202, 204, 206, 208 that are dynamically generated at run-time using corresponding web components 162 added to the layout of the web page GUI display 200. For example, a developer user may utilize the page builder feature of the application platform 124 to add instances of web component templates to a web page and define values for the fields associated with the respective web component templates. In this regard, the configurable web component templates generally represent self-contained and reusable elements or other resources that may be added or otherwise incorporated into a web page GUI display and generated or otherwise rendered at run-time in accordance with user-defined or user-configured values for various metadata fields or parameters of the respective web component template. For example, the configurable web component templates may correspond to configurable web components for various GUI elements, such as buttons, text boxes, lists, menus, and/or the like, which may be added to a web page GUI display in a drag and drop manner and then manually configured by a developer user. The page builder feature of the application platform 124 may be configurable to generate and store configured instances of the web component templates in the component database 160 as configured web components 162 associated with that user or tenant's instance of the virtual application 140 that maintains the user-defined values for the respective instances of the web component templates in association with the other code and/or data defining the layout, rendering, or behavior of the respective web component templates added to the respective web page GUI display.

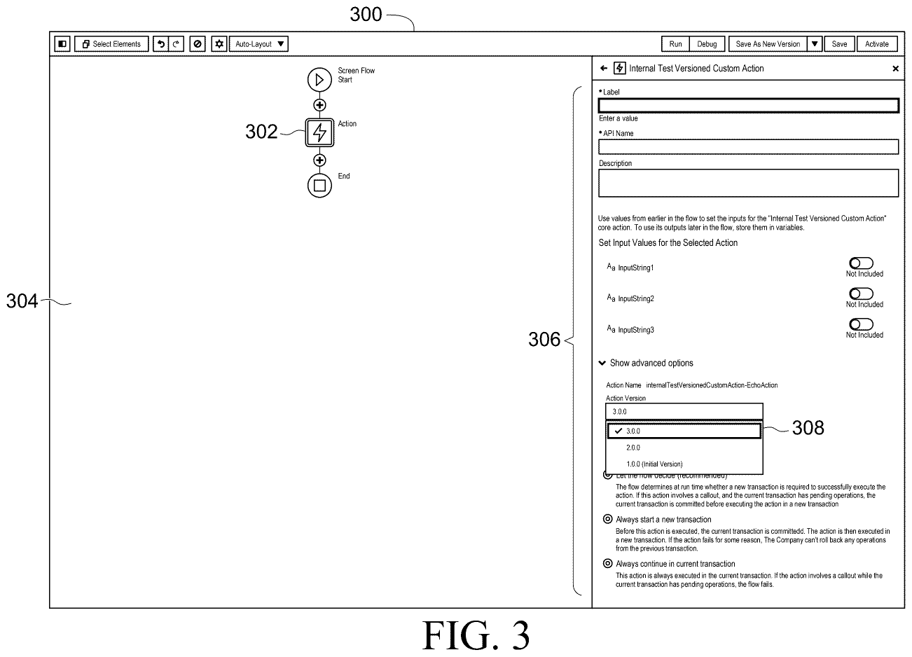

FIG. 3 depicts a process flow builder GUI display 300 that may be generated by a visual design feature of a virtual application 140 provided by the application platform 124 within the browser application 109 at the client device 108 in accordance with one or more implementations in connection with a developer user adding an action web component to a process flow defined within a process flow editing region 304 in a visual, WYSIWYG, drag and drop manner. In this regard, FIG. 3 depicts a state of the process flow builder GUI display 300 in a design mode after a developer user has dragged an instance of a configurable action web component 302 from a component menu sidebar region and dropping it at a desired relative location relative to other components within a process flow editing region of the process flow builder GUI display 300. After dropping or otherwise adding the instance 302 of a configurable action component template to the process flow editing region 304, the process flow builder GUI display 300 provides includes an action component definition sidebar region 306 that includes text boxes and other GUI elements that are configurable to allow the developer user to manually input or otherwise define values for the attributes, properties, or fields of metadata to be associated with the configured action web component 302.

Still referring to FIG. 3 with reference to FIG. 1, when the action web component 302 is configured for an API at an external system 170, the API integration service 142 utilizes the integration file 152 associated with the API to identify the different versions 172, 174, 176 associated with the API and automatically populates a drop-down list, a picklist or similar menu GUI element 308 using the versioning information identifying the different versions 172, 174, 176 of the API using the particular versioning schema used by the external system 170 to differentiate between the different versions 172, 174, 176. In this regard, the API integration service 142 utilizes the compare or sort functionality or other logical information the integration file 152 to arrange or order the different versions 172, 174, 176 within the drop-down list GUI element 308 in accordance with the particular ordering defined by the versioning schema associated with the external system 170, such that the drop-down list GUI element 308 is populated with an ordered listing of the different versions 172, 174, 176 based on their respective versioning at the external system 170 using the versioning schema of the external system 170 according to an ordering defined at the external system 170 within the integration file 152.

The developer user may utilize the drop-down list GUI element 308 to select or otherwise identify the particular API version 172, 174, 176 to be incorporated into the configured action web component 302, resulting in a respective configured web component 162 for the configured action web component 302 including code or other information identifying the particular API version 172, 174, 176 to be invoked in connection with execution of the configured action web component 302. For example, exemplary implementations of the configured web components 162 include presentation code (e.g., Hypertext Markup Language (HTML), cascading style sheet (CSS), and/or the like) defining the manner in which the configured web component 162 is to be displayed, rendered or otherwise presented by the client application 109, behavioral code (e.g., JavaScript or other client-side executable code) defining the event-driven behavior of the configured web component 162 within the client application 109 (e.g., in response to user actions, server actions, an event associated with another web component, etc.), and user-defined metadata for the configured web component 162 which may be invoked, referenced, or otherwise utilized by the presentation code and/or behavioral code to generate and render the configured web component 162. Thus, the configured web components 162 may be dynamic, with the content and/or behavior thereof varying each time a web page GUI display including one or more configured web component(s) 162 is viewed or accessed. In this regard, the configured web component 162 associated with the configured action web component 302 includes behavioral code and/or metadata that identifies the selected version 172, 174, 176 of the API at the external system 170 to be invoked in connection with execution of the configured web component 162. Thereafter, the code or file for the web page corresponding to the process is updated to incorporate or otherwise refer to the configured web component 162 corresponding to the configured action web component 302, where the code of the configured web component 162 includes indication of the user-configured version designation for the API at the external system 170.

Referring again to FIG. 1 with continued reference to FIGS. 2-3, when a user of a client application 109 at a client device 108 interacts with the application platform 124 to initiate, trigger or otherwise request a web page corresponding to an instance of the virtual application 140 that includes or otherwise incorporates the process flow, the application platform 124 retrieves or otherwise obtains the file or other code for the web page that includes reference to the configured web components 162 associated with the process flow. To generate a corresponding web page GUI display (e.g., web page GUI display 200) associated with the virtual application 140, the application platform 124 and/or the virtual application 140 executes the behavioral code and/or presentation code associated with the configured web components 162 using the metadata associated with the configured web components 162 to dynamically generate the respective web page GUI display in accordance with the predefined configuration. In this regard, in response to identifying a reference to a particular version of an API, endpoint or other invocable action at an external system 170, the application platform 124 and/or the virtual application 140 invokes the API integration service 142 to dynamically generate and construct a path for interacting with the designated API version 172, 174, 176 at the external system 170 using the integration file 152 associated with that API at the external system 170. For example, the API integration service 142 may utilize the user-selected or user-defined value for the version designation to parse the integration file 152 to retrieve versioning information and/or logical operation information to construct or otherwise generate a uniform resource locator (URL) address or other network address or path corresponding to the particular location of the designated API version 172, 174, 176 at the external system 170 at the on the network 110.

The application platform 124 and/or the virtual application 140 utilizes the dynamically constructed path for the reference to the desired API version 172, 174, 176 at the external system 170 to provide a corresponding request to the designated API version 172, 174, 176 at the external system 170 via the network 110 that includes appropriate values for any input parameters associated with the designated API version 172, 174, 176 and receive corresponding output data corresponding to the output of the respective API version 172, 174, 176 from the external system 170 via the network 110. Thereafter, the application platform 124 and/or the virtual application 140 utilizes the data retrieved from the external system 170 via the designated API version 172, 174, 176 to dynamically generate a graphical representation of one or more GUI display components 202, 204, 206, 208 using the retrieved data, such that the graphical representation of a respective GUI display component 202, 204, 206, 207 reflects data retrieved from the external system 170 using a particular version of the API or other endpoint the external system 170. In this manner, a web page GUI display incorporating data retrieved from external systems 170 may be dynamically generated at run-time in a manner that allows for the retrieved data to be obtained using any version of any available or exposed API or other endpoint, regardless of the versioning schema utilized at the external system 170.

It should be noted that although FIG. 3 depicts a version designation via a selectable GUI element 308 for purposes of illustration, the subject matter described herein is not limited to graphical definition or designation of a version to be invoked at run-time. In practice, the particular external API version to be incorporated into the virtual application 140 or a web component 162 may be defined programmatically using command line interfaces, REST APIs or other coding languages supported by the database system 102 to access the integration file 152 to identify and select the particular version of interested to be incorporated.

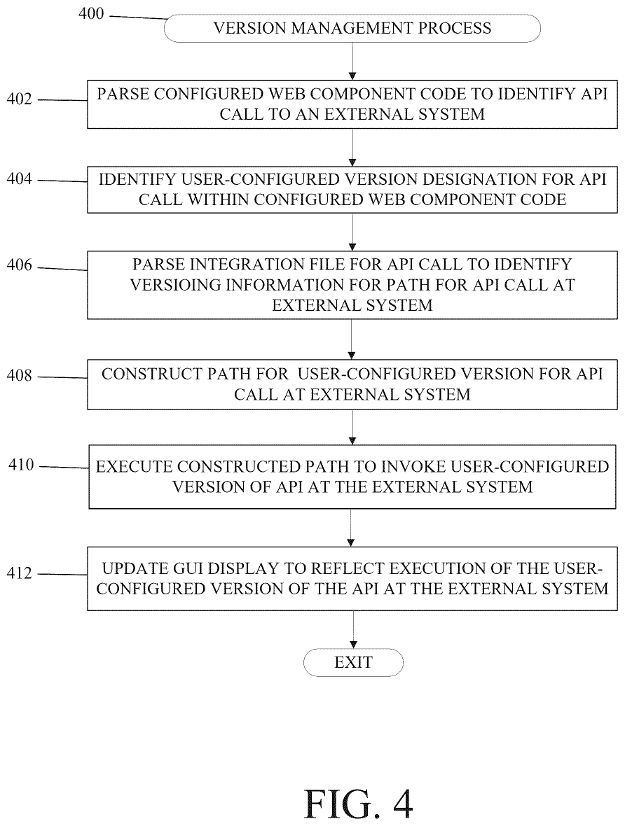

FIG. 4 depicts an exemplary version management process 400 suitable for implementation by an integration service associated with an application platform at a database system to interact with different versions of an API, action or other endpoint at an external system using versioning schema defined at the external system and perform additional tasks, functions, and/or operations described herein. For illustrative purposes, the following description may refer to elements mentioned above in connection with FIGS. 1-3. It should be appreciated that the version management process 400 may include any number of additional or alternative tasks, the tasks need not be performed in the illustrated order and/or the tasks may be performed concurrently, and/or the version management process 400 may be incorporated into a more comprehensive procedure or process having additional functionality not described in detail herein. Moreover, one or more of the tasks shown and described in the context of FIG. 4 could be omitted from a practical implementation of the version management process 400 as long as the intended overall functionality remains intact.

Referring to FIG. 4, with continued reference to FIGS. 1-3, in exemplary implementations, the version management process 400 is initiated or otherwise performed in response to user interaction with an instance of a virtual application to request a web page GUI display including one or more configured web components that incorporate a versioned reference to a particular API, action or other endpoint at an external system. The version management process 400 parses or otherwise analyzes the configured web component code to identify an API call or other reference to an endpoint at an external system and a corresponding user-configured version designation within the configured web component code (tasks 402, 404). For example, referring again to FIG. 3, the configured action web component 302 may store or otherwise maintain a value identifying the version (e.g., “3.0.0”) selected by the user via the drop-down list GUI element 308 for a version identifier parameter or field of metadata associated with the configure action web component 302. In such implementations, the integration service 142 parses or otherwise analyzes the configured action web component 162, 302 to identify the stored user-configured value for the version identifier parameter or field of metadata.

After identifying the particular reference to a particular external system and a particular version designation for that reference, the version management process 400 parses or otherwise analyzes the integration file associated with that reference and external system to identify versioning information for constructing a path for interacting with the desired user-configured version of that reference according to the versioning schema defined at the external system and dynamically constructing or otherwise generating a path for interacting with the identified user-configured version of the reference at the external system (tasks 406, 408). In this regard, the integration service 142 translates or otherwise converts a generic reference to a particular API at the external system 170 along with version designation information into a versioned network path or URL address for invoking the desired API version 172, 174, 176 in accordance with the custom versioning schema at the external system 170 using the versioning information contained in the integration file. For example, referring to FIG. 3, after identifying the version value of 3.0.0 for the version identifier parameter or field of metadata of the configured action web component 162, 302, the integration service 142 may automatically convert a generic reference to an API at the external system 170 (e.g., “POST /actions/externalSystemAction”) within the behavioral code of the configured action web component 162, 302 into a URL address or other path corresponding to versioned reference to the particular API version (e.g., “POST /actions/externalSystemAction@3.0.0”) when generating the configured action web component 162, 302 at run-time prior to providing the generated action web component to the virtual application 140 and/or the client application 109 for execution. In this regard, it should be noted that the versioned reference may vary depending on the particular schema used at the eternal system 170 and the particular configuration of the web component (e.g., POST /actions/externalSystemAction@2.0.1, POST/actions/partnerSystemAction@beta, POST /actions/partnerSystemAction@release, and/or the like), and the subject matter described herein is not limited to any particular versioning schema or configuration.

After constructing a versioned path for invoking the desired version of the API call, action or other endpoint at the external system, the version management process 400 executes the constructed versioned path to invoke the desired user-configured version at the external system to retrieve data from the external system and dynamically updates a GUI display using the retrieved data to reflect execution of the user-configured version of the API call, action or other endpoint at the external system (tasks 410, 412). For example, the integration service 142 may provide the dynamically constructed versioned path for invoking the particular one of the API versions 172, 174, 176 at the external system 170 that was designated or otherwise configured previously by a user when defining a configured web component 162 to the virtual application 140, which, in turn utilizes the versioned path to generate or otherwise provide a request to the external system 170 that includes the appropriate input parameter values for the designated API version 172, 174, 176. In response to the request, the external system 170 implements or otherwise executes the requested one of the API versions 172, 174, 176 using the input values received from the virtual application 140 to perform one or more actions associated with the API at the external system 170 and output or otherwise provide corresponding response data back to the virtual application 140 in response to the request. The virtual application 140 utilizes the retrieved data from the external system 170 to dynamically generate a graphical representation of the configured web component 162 that included the versioned reference to the API at the external system 170 or otherwise dynamically updates a GUI display of the virtual application 140 to reflect the data retrieved using the particular version of the API at the external system 170.

By virtue of the subject matter described herein, the integration service 142 and/or the version management process 400 allows for any number of different versions of APIs, invocable actions or other endpoints at any number of different external systems to be incorporated into a virtual application at a database system via user-configurable web components without imposing any constraints or requirements on the versioning schema to be utilized at the external system(s). In this regard, the APIs, invocable actions or other endpoints may be versioned, defined or otherwise differentiated from one another at the respective external system(s) using any sort of versioning schema or conventions desired by an administrator of that respective external system, which may be unique to that external system or otherwise different from the versioning schema utilized at the database system. Thus, third party or other external APIs or endpoints can be incorporated into virtual applications at the database system without any changes to the versioning at the external system(s).

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read-only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals-such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as services) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

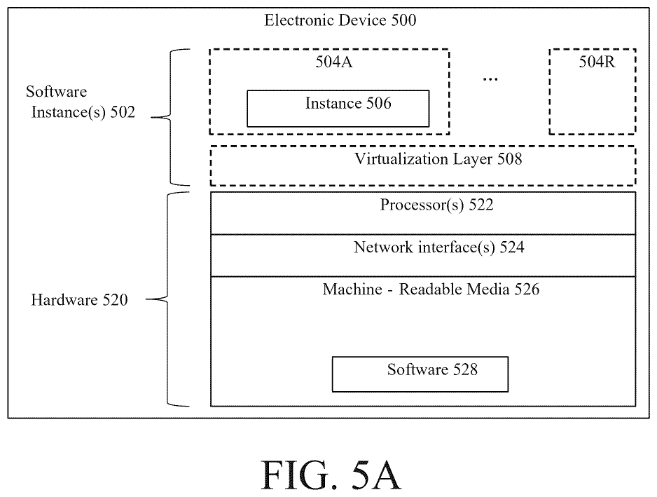

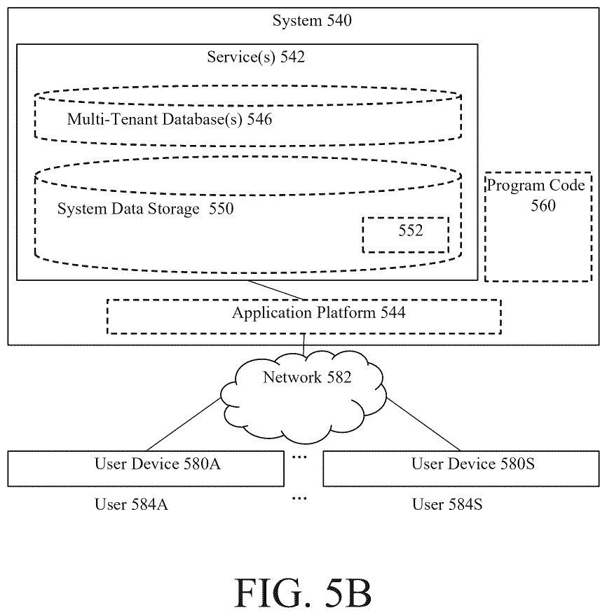

FIG. 5A is a block diagram illustrating an electronic device 500 according to some example implementations. FIG. 5A includes hardware 520 comprising a set of one or more processor(s) 522, a set of one or more network interfaces 524 (wireless and/or wired), and machine-readable media 526 having stored therein software 528 (which includes instructions executable by the set of one or more processor(s) 522). The machine-readable media 526 may include non-transitory and/or transitory machine-readable media. Each of the previously described applications and related services may be implemented in one or more electronic devices 500. In one implementation: 1) each of the clients is implemented in a separate one of the electronic devices 500 (e.g., in end user devices where the software 528 represents the software to implement clients to interface directly and/or indirectly with the virtual application and/or integration service (e.g., software 528 represents a web browser, a native client, a portal, a command-line interface, and/or an application programming interface (API) based upon protocols such as Simple Object Access Protocol (SOAP), Representational State Transfer (REST), etc.)); 2) the virtual application and/or integration service is implemented in a separate set of one or more of the electronic devices 500 (e.g., a set of one or more server devices where the software 528 represents the software to implement the virtual application and/or integration service); and 3) in operation, the electronic devices implementing the clients and the virtual application and/or integration service would be communicatively coupled (e.g., by a network) and would establish between them (or through one or more other layers and/or or other services) connections for submitting requests to the virtual application and/or integration service. Other configurations of electronic devices may be used in other implementations (e.g., an implementation in which the client and the virtual application and/or integration service are implemented on a single one of electronic device 500).

During operation, an instance of the software 528 (illustrated as instance 506 and referred to as a software instance; and in the more specific case of an application, as an application instance) is executed. In electronic devices that use compute virtualization, the set of one or more processor(s) 522 typically execute software to instantiate a virtualization layer 508 and one or more software container(s) 504A-504R (e.g., with operating system-level virtualization, the virtualization layer 508 may represent a container engine (such as Docker Engine by Docker, Inc. or rkt in Container Linux by Red Hat, Inc.) running on top of (or integrated into) an operating system, and it allows for the creation of multiple software containers 504A-504R (representing separate user space instances and also called virtualization engines, virtual private servers, or jails) that may each be used to execute a set of one or more applications; with full virtualization, the virtualization layer 508 represents a hypervisor (sometimes referred to as a virtual machine monitor (VMM)) or a hypervisor executing on top of a host operating system, and the software containers 504A-504R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 528 is executed within the software container 504A on the virtualization layer 508. In electronic devices where compute virtualization is not used, the instance 506 on top of a host operating system is executed on the “bare metal” electronic device 500. The instantiation of the instance 506, as well as the virtualization layer 508 and software containers 504A-504R if implemented, are collectively referred to as software instance(s) 502.

Alternative implementations of an electronic device may have numerous variations from that described above. For example, customized hardware and/or accelerators might also be used in an electronic device.

FIG. 5B is a block diagram of a deployment environment according to some example implementations. A system 540 includes hardware (e.g., a set of one or more server devices) and software to provide service(s) 542, including one or more services configurable to support a virtual application and/or an integration service. In some implementations the system 540 is in one or more datacenter(s). These datacenter(s) may be: 1) first party datacenter(s), which are datacenter(s) owned and/or operated by the same entity that provides and/or operates some or all of the software that provides the service(s) 542; and/or 2) third-party datacenter(s), which are datacenter(s) owned and/or operated by one or more different entities than the entity that provides the service(s) 542 (e.g., the different entities may host some or all of the software provided and/or operated by the entity that provides the service(s) 542). For example, third-party datacenters may be owned and/or operated by entities providing public cloud services (e.g., Amazon. com, Inc. (Amazon Web Services), Google LLC (Google Cloud Platform), Microsoft Corporation (Azure)).

The system 540 is coupled to user devices 580A-580S over a network 582. The service(s) 542 may be on-demand services that are made available to one or more of the users 584A-584S working for one or more entities other than the entity which owns and/or operates the on-demand services (those users sometimes referred to as outside users) so that those entities need not be concerned with building and/or maintaining a system, but instead may make use of the service(s) 542 when needed (e.g., when needed by the users 584A-584S). The service(s) 542 may communicate with each other and/or with one or more of the user devices 580A-580S via one or more APIs (e.g., a REST API). In some implementations, the user devices 580A-580S are operated by users 584A-584S, and each may be operated as a client device and/or a server device. In some implementations, one or more of the user devices 580A-580S are separate ones of the electronic device 500 or include one or more features of the electronic device 500.

In some implementations, the system 540 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants. In one implementation, the system 540 is a multi-tenant cloud computing architecture supporting multiple services, such as one or more of the following types of services: Customer relationship management (CRM); Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Authorization; Authentication; Security; and Identity and access management (IAM). For example, system 540 may include an application platform 544 that enables PAAS for creating, managing, and executing one or more applications developed by the provider of the application platform 544, users accessing the system 540 via one or more of user devices 580A-580S, or third-party application developers accessing the system 540 via one or more of user devices 580A-580S.

In some implementations, one or more of the service(s) 542 may use one or more multi-tenant databases 546, as well as system data storage 550 for system data 552 accessible to system 540. In certain implementations, the system 540 includes a set of one or more servers that are running on server electronic devices and that are configured to handle requests for any authorized user associated with any tenant (there is no server affinity for a user and/or tenant to a specific server). The user devices 580A-580S communicate with the server(s) of system 540 to request and update tenant-level data and system-level data hosted by system 540, and in response the system 540 (e.g., one or more servers in system 540) automatically may generate one or more Structured Query Language (SQL) statements (e.g., one or more SQL queries) that are designed to access the desired information from the multi-tenant database(s) 546 and/or system data storage 550.

In some implementations, the service(s) 542 are implemented using virtual applications dynamically created at run time responsive to queries from the user devices 580A-580S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 562 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 544 includes an application setup mechanism that supports application developers' creation and management of applications, which may be saved as metadata by save routines. Invocations to such applications, including by the virtual application and/or integration service, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 582 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a third Generation Partnership Project (3GPP) protocol, a fourth generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 540 and the user devices 580A-580S.

Each user device 580A-580S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 540. For example, the user interface device can be used to access data and applications hosted by system 540, and to perform searches on stored data, and otherwise allow one or more of users 584A-584S to interact with various GUI pages that may be presented to the one or more of users 584A-584S. User devices 580A-580S might communicate with system 540 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 580A-580S might include an HTTP client, commonly referred to as a “browser,” for sending and receiving HTTP messages to and from server(s) of system 540, thus allowing users 584A-584S of the user devices 580A-580S to access, process and view information, pages and applications available to it from system 540 over network 582.

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting. Accordingly, details of the exemplary implementations described above should not be read into the claims absent a clear intention to the contrary.

1. A method comprising:
receiving, at a database system from a client application at a client device over a network, a request for a graphical user interface (GUI) display associated with a virtual application supported by the database system;
identifying, at the database system, a component of the GUI display comprising a reference to an application programming interface (API) at an external system coupled to the database system over the network;
identifying, at the database system within code associated with the component of the GUI display, a version designation for the API at the external system using a versioning schema associated with the external system, wherein the versioning schema associated with the external system is different from a standard versioning schema associated with the database system;
dynamically constructing, at the database system at run-time, a versioned network path for interacting with a designated version of the API at the external system using the version designation and an integration file associated with the external system;
providing, by the database system over the network, a second request to the external system that includes input parameter values for the designated version of the API at the external system using the versioned network path to retrieve, at the database system, data from the external system over the network via the designated version of the API at the external system; and
generating, using the data retrieved from the external system in accordance with the version designation, a graphical representation of the component within the GUI display of the virtual application provided to the client application at the client device.

2. The method of claim 1, wherein the component of the GUI display comprises a configured web component associated with the GUI display that includes the reference to the API at the external system.

3. (canceled)

4. The method of claim 1, wherein the versioning schema comprises a custom versioning schema associated with the external system that is different from the standard versioning schema associated with the database system.

5. The method of claim 2, wherein generating the graphical representation of the component comprises generating a graphical representation of the configured web component using the data retrieved from the versioned network path for the version designation of the API at the external system.

6. The method of claim 1, wherein:
dynamically constructing the versioned network path comprises generating a uniform resource locator (URL) address for an endpoint at the external system associated with the version designation for the API using the integration file; and
retrieving the data comprises the virtual application at the database system retrieving the data using the URL address to generate the graphical representation of the component within the GUI display associated with the virtual application.

7. A method comprising:
identifying, at a database system, an action added to a region on a graphical user interface (GUI) display at a client device corresponding to an action component of a virtual application, wherein the action comprises a reference to an application programming interface (API) at an external system coupled to the database system over a network;
identifying, at the database system, a plurality of different versions associated with the action based at least in part on an integration file associated with the external system at the database system;
populating, by the database system, a GUI element within the GUI display at the client device with the plurality of different versions associated with the action using the integration file;
identifying, at the database system, a version designation of the plurality of different versions for the API at the external system using a versioning schema associated with the external system via the GUI element, wherein the versioning schema associated with the external system is different from a standard versioning schema associated with the database system;
automatically generating, at the database system, configured code for the action component comprising indication of the version designation for the API at the external system using the versioning schema associated with the external system; and
updating code for a web page associated with the virtual application to include the configured code for the action component, wherein the virtual application is configurable to dynamically construct at run-time a versioned network path for interacting with a designated version of the API at the external system using the indication of the version designation of the configured code and the integration file associated with the external system and the action component is configured to provide, over the network, a request to the external system that includes input parameter values for the designated version of the API at the external system using the versioned network path to retrieve data from the external system over the network via the designated version of the API at the external system.

8. The method of claim 7, wherein identifying the version designation comprises identifying a user configuration of the GUI element on the GUI display corresponding to the version designation of the plurality of different versions.

9. The method of claim 8, wherein:
populating the GUI element comprises populating a drop-down menu GUI element with an ordered listing of the plurality of different versions according to an ordering defined at the external system within the integration file; and
identifying the user configuration comprises identifying the designated version of the plurality of different versions selected by a user of the client device within the ordered listing via the drop-down menu GUI element.

10. The method of claim 9, wherein:
automatically generating the configured code comprises generating a configured action web component comprising the indication of the version designation for the API at the external system.

11. The method of claim 10, wherein updating the code for the web page comprises updating the code for the web page to incorporate the configured action web component.

12. (canceled)

13. The method of claim 7, wherein populating the GUI element comprises populating a drop-down menu GUI element with an ordered listing of the plurality of different versions using respective versions of the plurality of different versions according to an ordering defined at the external system within the integration file.

14. (canceled)

15. A non-transitory machine-readable storage medium that provides instructions that, when executed by a processor, are configurable to cause the processor to perform operations comprising:
receiving, from a client application at a client device over a network, a request for a graphical user interface (GUI) display associated with a virtual application supported by a database system;
identifying a component of the GUI display comprising a reference to an application programming interface (API) at an external system coupled to the database system over the network and a version designation for the reference to the external system within code associated with the component of the GUI display, the version designation using a versioning schema associated with the external system, the versioning schema being different from a standard versioning schema associated with the database system;
dynamically constructing, at run-time, a versioned network path for interacting with a designated version of the API at the external system using the version designation and an integration file associated with the external system;
providing, over the network, a second request to the external system that includes input parameter values for the designated version of the API at the external system using the versioned network path to retrieve data from the external system over the network via the designated version of the API at the external system; and
generating, based on the data retrieved from the external system in accordance with the version designation, a graphical representation of the component within the GUI display of the virtual application provided to the client application at the client device.

16. The non-transitory machine-readable storage medium of claim 15, wherein:
the component comprises a configured web component associated with the GUI display that includes the reference to the API.

17. (canceled)

18. The non-transitory machine-readable storage medium of claim 15, wherein the version designation uses a custom versioning schema associated with the external system.

19. The non-transitory machine-readable storage medium of claim 15, wherein:
the component comprises a configured web component associated with the GUI display; and
the instructions are configurable to cause the processor to generate a graphical representation of the configured web component using the data retrieved from the versioned network path for the version designation of the API at the external system.

20. The non-transitory machine-readable storage medium of claim 15, wherein the versioned network path comprises a uniform resource locator (URL) address for an endpoint at the external system associated with the version designation for the API.

21. The method of claim 7, wherein the versioned network path comprises a uniform resource locator (URL) address for an endpoint at the external system associated with the version designation for the API.
